(19) United States
(12) Patent Application Publication
(10) Pub. No.: US 2026/0077819 A1
(43) Pub. Date: Mar. 19, 2026

(54) WATER CHANNEL ASSEMBLY FOR AN AUTOMOTIVE VEHICLE AND METHOD FOR FORMING THE SAME

(71) Applicant: FCA US LLC, Auburn Hills, MI (US)

(72) Inventors: Fan Qiang, Shanghai (CN); Cao Chengcheng, Shanghai (CN); Tian Bingkun, Shanghai (CN)

(21) Appl. No.: 18/884,240

(22) Filed: Sep. 13, 2024

(51) Int. Cl. B62D 25/24; B62D 27/02

(52) U.S. Cl. CPC B62D 25/24; B62D 27/026

(57) ABSTRACT

A vehicle includes a first member and a second member joined to the first member to form a channel. A welding glue deposition is disposed across a width of the channel. An electrophoretic coating is disposed on the first member, the second member and the channel.

### FIELD

The present disclosure relates generally to forming an automotive vehicle and, more specifically, to a water channel and method of forming the same.

### BACKGROUND

This section provides background information related to the present disclosure which is not necessarily prior art.

In forming a vehicle out of metal, electrophoretic material or coating is used to reduce the effects of corrosion on the vehicle. Electrophoresis may also be referred to a cataphoresis when the charged particles are positively charged. The positively charged particles are dispersed within the electrophoretic coating that is applied to a vehicle. During the process, the electrophoretic material is applied and then the vehicle is heated in an oven. During heating in the oven, the electrophoretic material may run and collect in areas of the vehicle such as a channel. Excess electrophoretic material may also run from the channel onto a finished surface causing drips to solidify in the oven causing an uneven finish. Rework must be performed prior to painting. That is, the painting process requires a smooth finished surface that must be free of drips from the electrophoretic process. Preventing the drips and thus reworking the product is important.

### SUMMARY

This section provides a general summary of the disclosure, and is not a comprehensive disclosure of its full scope or all of its features.

A vehicle is formed with welding glue that forms a blocking device with the deposition of welding glue across a channel to prevent dripping during the oven baking process of the electrophoretic coating.

In one aspect of the disclosure, a vehicle includes a first member and a second member joined to the first member to form a channel. A welding glue deposition is disposed across a width of the channel. An electrophoretic coating is disposed on the first member, the second member and the channel.

In another aspect of the disclosure, a method of forming a vehicle includes joining a first member and a second member to form a channel, forming a welding glue deposition across the channel, coating the welding glue deposition and the channel with electrophoretic material, heating the first member and the second member in an oven and retaining electrophoretic material in the channel during heating.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a rear view of a body of a vehicle having a channel formed according to the present disclosure.

FIG. 1B is a close up of the channel formed in the vehicle.

FIG. 1C is an even closer view of the channel showing the thickness of the welding glue deposition.

FIG. 1D is a top view of a channel having the welding glue deposition thereacross.

FIG. 2 is a flowchart of a method for forming a body of a vehicle.

### DETAILED DESCRIPTION

Example embodiments will now be described more fully with reference to the accompanying drawings.

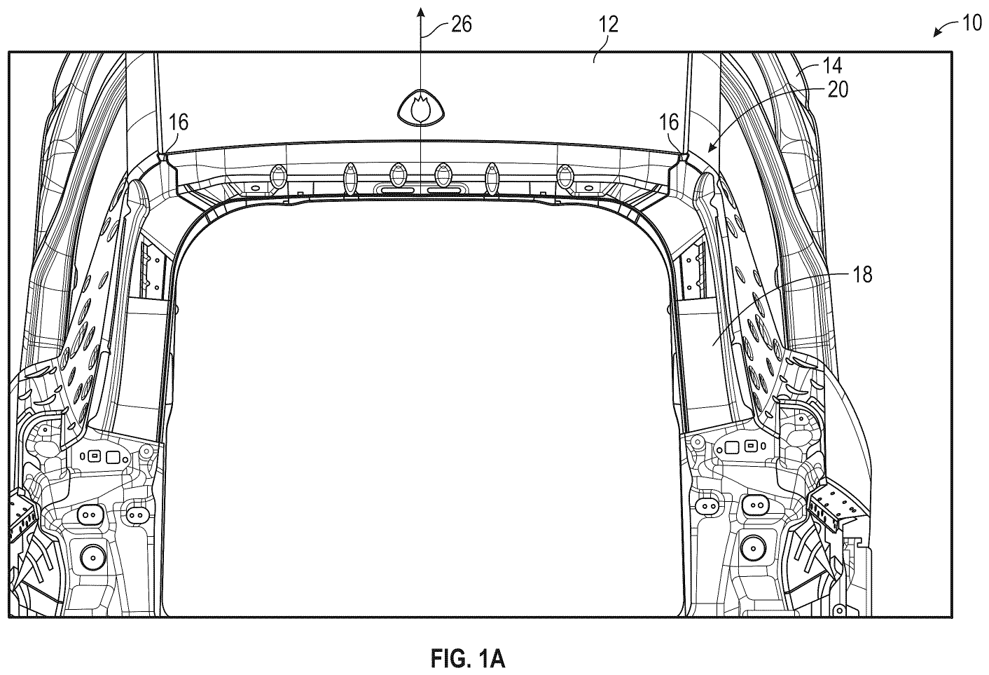

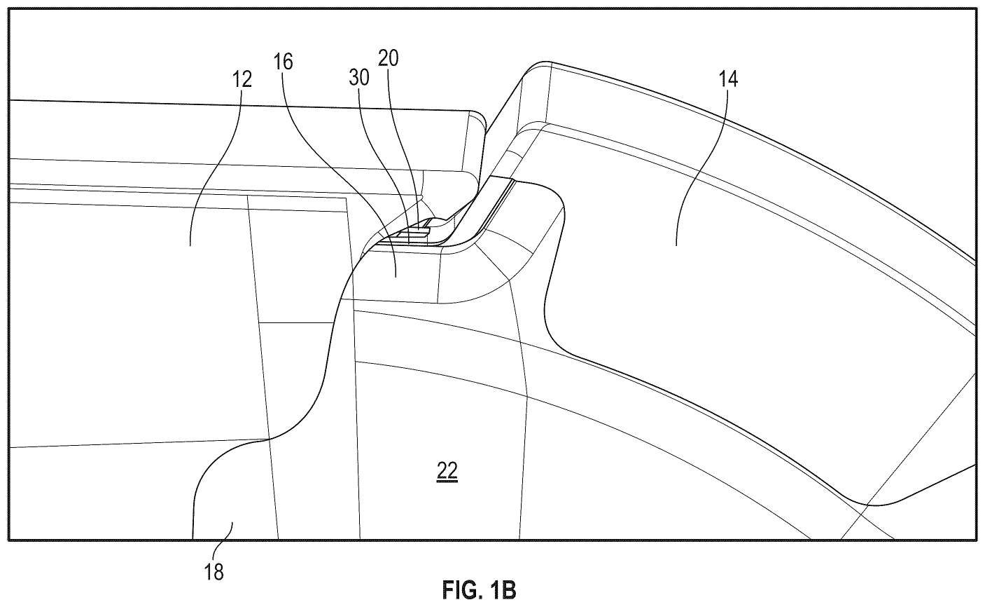

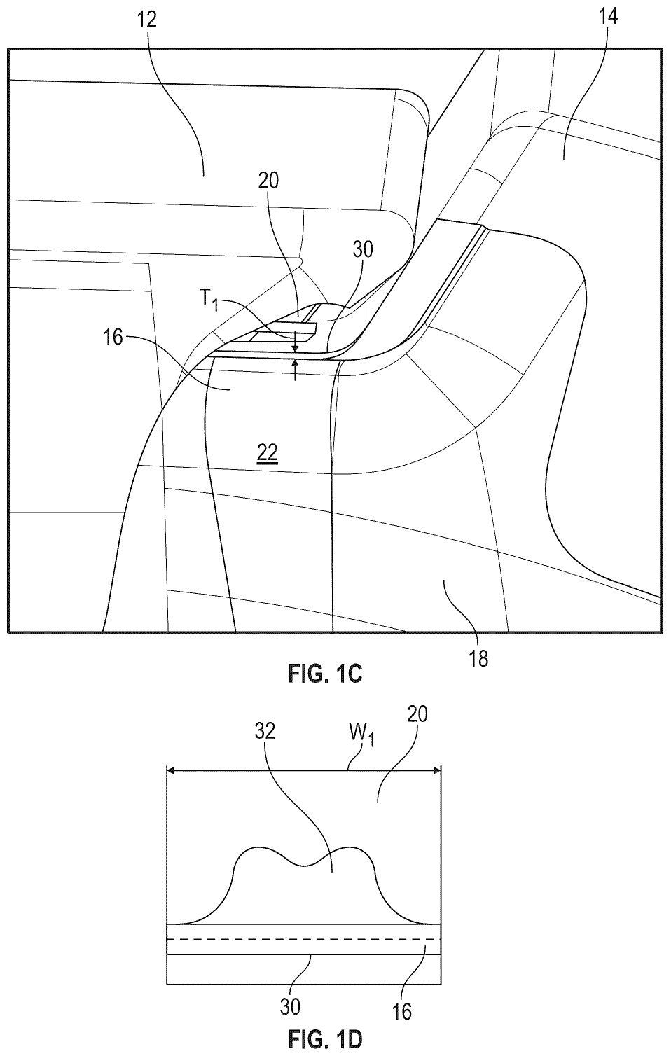

Referring now to FIG. 1, a vehicle 10 is partially illustrated having a roof panel 12, a side body panel 14, a water channel outlet 16 and a rear panel 18. The roof panel 12, the side panel 14, water channel outlet 16 and the rear panel 18 may be referred to as members. The members such as the roof panel 12 and the side panel 14 are joined together to form a channel 20 that is illustrated best in FIGS. 1B and 1C in greater detail. During vehicle operation water leaves the channel 20 at the water channel outlet 16. The rear panel 18 has the water channel outlet 16 stamped therein. The rear panel 18 and has a finished surface 22 disposed thereon. Should an electrophoretic coating be allowed to flow from the channel 20 to the water channel outlet 16, the finished surface 22 may have hardened drips that must be reworked to the final painting or coating process for the vehicle 10. In one example, the electrophoretic material or coating is a cataphoretic material or coating.

In this example, the roof panel 12 may be a sunroof panel. The channel 20 is elongated and formed between the roof panel 12 and the side panel 14. At a rearward end of the channel 20, the rear panel 18 is also joined and has the water channel outlet 16 therein to form the channel 20 as is best shown in FIG. 1D. The channel 20 may be referred to as a water channel in that water from the roof panel 12 may collect within the channel 20 to drain rearward of the vehicle 10 during operation. The vehicle 10 has a longitudinal axis 26 and the channel 20 is elongated and is disposed longitudinally within the vehicle 10.

The rear panel 18 has a welding glue deposition 30 that extends across a width W₁ of the channel 20 and water channel outlet 16 as illustrated best in FIGS. 1C and 1D. The welding glue deposition 30 is disposed laterally across the channel 20 relative to the vehicle 10. A thickness T₁ illustrated in FIG. 1D illustrates the minimum effective height above the channel to allow some of the electrophoretic material to be captured and prevent runoff onto the rear panel 18. The thickness T₁ of the welding glue deposition 30 in constructed examples was 3 to 5 mm. However, various thicknesses of welding glue deposition may be used depending upon the amount of coating expected from the adjacent panels. The thickness T₁ of the welding glue deposition 30 forms a block or dam for electrophoretic material or coating 32 generally represented in FIG. 1D. The block or dam allows the electrophoretic material to collect and not run out of the channel during oven heating. The thickness of the electrophoretic material or coating 32 does not rise higher than the thickness T₁ according to design considerations during the oven heating. Suitable welding glue materials include but are not limited to PF380 or GMB330AL.

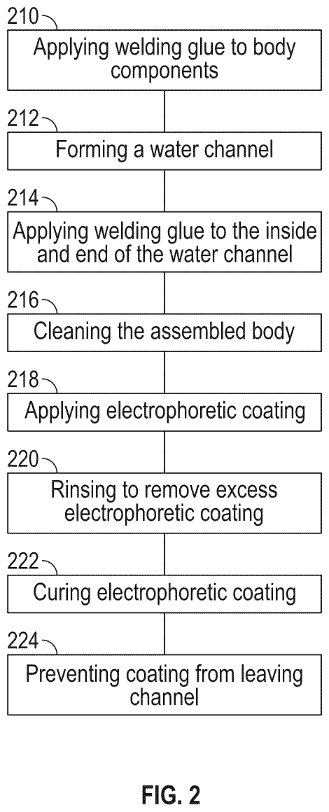

Referring now to FIG. 2, a method of forming a vehicle 10 is set forth. In this example, a welding glue deposition machine (not shown) is used to apply welding glue to various body components, panels, or members. The body members such as the roof panel and side panel form the water channel 20 in step 212. They may be spot welded. During the formation of the body or after the formation of the body, step 214 applies welding glue to the inside and end of the water channel and the water channel outlet 16 to form the welding glue deposition 30. In this example, the water channel is merely one example of a type of channel. The water channel outlet 16 has a longitudinal end toward the rear of the vehicle that has welding glue applied thereto. The welding glue deposition 30, illustrated in FIGS. 1C and 1D, form a blocking structure to block the movement of the electrophoretic coating to position outside the channel such as onto the rear panel or member 18 illustrated in FIG. 1A. After the application of welding glue, the optional step of cleaning the assembled body is performed in step 216. Several types of cleaning methods may be used depending upon the materials. The electrophoretic coating is applied in step 218. A rinsing process 220 may optionally be performed to remove the excess electrophoretic coating. In step 222, the electrophoretic coating is cured onto the body assembly. As mentioned above, the electrophoretic coating may become liquid and may have a tendency to collect and be retained within the channel. In step 224, the coating is prevented from leaving the channel by the welding glue deposition and remains therein during the hardening process. Ultimately, the electrophoretic coating hardens and may then be coated with paint at the end of the channel.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “they” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be taken.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a first member;
a second member joined to the first member to form a channel;
a welding glue deposition across a width of the channel; and
an electrophoretic coating disposed on the first member, the second member and the channel.

2. The vehicle of claim 1 wherein the channel comprises a water channel.

3. The vehicle of claim 1 wherein the channel is an elongated channel.

4. The vehicle of claim 3 wherein the elongated channel is oriented longitudinally relative to the vehicle.

5. The vehicle of claim 1 wherein the welding glue deposition is disposed laterally within the channel relative to the vehicle.

6. The vehicle of claim 1 wherein the first member comprises a body panel.

7. The vehicle of claim 1 wherein the second member comprises a water channel outlet.

8. The vehicle of claim 1 wherein the first member comprises a body panel, the second member comprises a water channel outlet and further comprising a third member comprising a roof panel.

9. The vehicle of claim 8 wherein the welding glue deposition is at least partially disposed at the water channel outlet.

10. The vehicle of claim 9 wherein the third member is a rear panel.

11. A method of forming a vehicle comprising:
joining a first member and a second member to form a channel;
forming a welding glue deposition across the channel;
coating the welding glue deposition and the channel with electrophoretic material;
heating the first member and the second member in an oven; and
retaining electrophoretic material in the channel during heating.

12. The method of claim 11 wherein joining the first member to the second member comprises applying a welding glue between the first member and the second member.

13. The method of claim 11 wherein joining the first member and the second member to form the channel comprises joining the first member and the second member to form an elongated channel.

14. The method of claim 11 wherein joining the first member and the second member to form the channel comprises joining the first member and the second member to form an elongated channel oriented longitudinally relative to the vehicle.

15. The method of claim 11 wherein joining the first member and the second member to form the channel comprises joining a body panel and a water channel outlet to form the channel.

16. The method of claim 11 wherein joining the first member to the second member comprises joining the first member, the second member and a third member to form the channel.

17. The method of claim 16 wherein joining the first member, the second member and the third member to form the channel comprises joining a body panel, a water channel outlet, and a roof panel.

18. The method of claim 11 wherein coating the welding glue deposition and the channel with electrophoretic material comprise coating the welding glue deposition and the channel with cataphoretic material.
